(19) United States
(12) Patent Application Publication
(10) Pub. No.: US 2020/0273112 A1
(43) Pub. Date: Aug. 27, 2020

(54) METHOD AND APPARATUS FOR INSURING MULTIPLE UNIT DWELLINGS

(71) Applicant: Renters Legal Liability, LLC, Salt Lake City, UT (US)

(72) Inventors: Steve Errico, Charleston, SC (US); Marcellus Barrus, Salt Lake City, UT (US)

(73) Assignee: Renters Legal Liability, LLC, Salt Lake City, UT (US)

(21) Appl. No.: 16/861,596

(22) Filed: Apr. 29, 2020

Related U.S. Application Data
(63) Continuation-in-part of application No. 15/902,512, filed on Feb. 22, 2018, now abandoned.
Application No. 15/902,512 is a continuation-in-part of application No. 11/274,875, filed on Nov. 15, 2005, now abandoned.
Application No. 11/274,875 is a continuation-in-part of application No. 11/134,643, filed on May 23, 2005, now abandoned.
Application No. 11/134,643 is a continuation-in-part of application No. 11/020,152, filed on Dec. 27, 2004, now abandoned.
Application No. 11/020,152 is a continuation-in-part of application No. 09/947,330, filed on Sep. 7, 2001, now abandoned.
Application No. 09/947,330 is a continuation-in-part of application No. 09/921,251, filed on Aug. 3, 2001, now abandoned.

(51) Int. Cl. G06Q 40/08; G06Q 50/16

(52) U.S. Cl. CPC G06Q 40/08; G06Q 50/163

(57) ABSTRACT

A computer system and method for insuring the owner of an apartment or multi-unit dwelling from damage to his building caused by his tenant's unintentional acts comprising: inputting into a computer system a database of building physical information, occupancy information, and tenant rental information; inputting into the computer an insurance qualification program for renters legal liability insurance covering the building owner from unintentional damage caused by the tenant from fire, smoke, explosion, water discharge, and sewer backup, or negligence injuries by the tenant caused to third parties pursuant to predetermined insurability criteria; qualifying the building for renters legal liability insurance, and computer translating and generating insurance coverage for the building owner based on the number of units in the building and insurance coverage limits desired, and billing the owner for renter's legal liability insurance.

### CROSS-REFERENCED RELATED APPLICATIONS

This application is a continuation-in-part of the continuation-in-part of the United States application entitled METHOD AND APPARATUS FOR INSURING MULTIPLE UNIT DWELLINGS, filed Feb. 22, 2018, Ser. No. 15/902,512, which is

a continuation-in-part of the continuation-in-part of United States application entitled METHOD AND APPARATUS FOR INSURING MULTIPLE UNIT DWELLINGS, filed Nov. 15, 2005, Ser. No. 11/274,875,

of the continuation-in-part of the continuation-in-part application of United States patent application entitled METHOD AND APPARATUS FOR INSURING MULTIPLE UNIT DWELLINGS, filed May 23, 2005, Ser. No. 11/134,643

of the continuation-in-part of the continuation-in-part application of United States Letters Patent entitled METHOD AND APPARATUS FOR INSURING MULTIPLE UNIT DWELLINGS, filed Dec. 27, 2004, Ser. No. 11/020,152

of the continuation-in-part of the continuation-in-part application filed Sep. 7, 2001, Ser. No. 09/947,330 entitled “Method and Apparatus for Insuring Multiple Unit Dwellings”

of the continuation-in-part application filed Aug. 3, 2001, Ser. No. 09/921,251 entitled “Method and Apparatus for Insuring Multiple Unit Dwellings”

of the original application entitled “Method and Apparatus for Insuring Multiple Unit Dwellings”, Ser. No. 09/476,559 filed Jan. 3, 2000.

### BACKGROUND OF THE INVENTION

### Field

This invention relates to methods for insuring owners of tenants occupied multiple unit dwellings and buildings. More particularly, it relates to a computer system and method to insure the owner of apartments or multi-unit dwellings from accidental losses caused by their tenants.

### State of the Art

Joint insurance coverage for owners of and tenants occupying multiple dwelling units in a building is currently not possible to write, because it is cost prohibitive to issue a large number of small policies covering individual units. Further, many lease clauses require renter's insurance coverage. However, approximately 90% of the 35 million apartment units in the United States are currently uninsured. Landlords currently do not have an effective process to verify or enforce the lease requirements of mandatory insurance. This places an enormous burden on the property managers to try and maintain adequate insurance coverage for the building owner. The property managers have a significant challenge to make sure all their occupied units are covered either by a resident's policy (HO4) or a waiver based owner's policy. One of the most significant challenges is to track and communicate the coverage changes that happen daily. Changes in coverage occur when a resident's policy expires or is canceled for any reason such as non-payment. Residents may initially choose to waive their right to their policy and activate the owners' policy then choose their own policy at a later date. Coverage changes also based on occupancy changes (move-in or Move-out). This challenge becomes even more difficult to manage with a larger number of units. If these changes are not kept current then the units can become at risk.

The patent references of record fail to suggest a computerized system to provide insurance coverage to protect both the landlord and tenant from negligent acts by the tenant that affect the building owner from unintentional tenant acts causing fire, smoke, explosion and water damage to the building units, whether occupied or not. Luchs et al, U.S. Pat. No. 4,831,526 issued in 1989 discloses a computerized insurance premium quote request and policy issuance system primarily for use in the automotive, watercraft, dwelling, and personal liability insurance area. The method disclosed provides for preparing and writing insurance contracts via computer terminals and correction displays before printing out the policy. It does not address providing limited streamlined multi-unit coverage via an automated coverage management system to reduce the high risk of units without coverage and to provide reduced group rate insurance to building owners.

Dillard, U.S. Pat. No. 6,236,973B1 issued May 22, 2001 is an apparatus and method for providing collateral construction loan insurance coverage. It addresses a centralized automated apparatus for lending institutions to track insurance coverage on buildings used as collateral for construction loans under a single builder's risk policy. This apparatus provides management reports for the lending institution, and tracks premium payments and repayments for closed loans, and loss evaluations. Again, this reference does not address providing limited streamlined multi-unit group multi-unit coverage via an encrypted database to provide reduced group rate insurance to building owners.

Brown et al., U.S. Pat. No. 5,978,769 issued Nov. 2, 1999 is a system and method for determining and analyzing building occupancy using geographically based structures to identify potential clients, perform carrier exposure aggregation and associated with operations performed by other occupants. This reference does not address issuing limited streamlined multi-group multi-unit coverage for the building owner based on a novel encrypted database, but is used as an actuarial risk-assessment rating tool.

Other business method patents address using computers to gather information from building sales and complexes to generate reports, which value and manage business complexes based on information concerning each unit in the building. Weatherly et al, U.S. Pat. No. 6,023,687 issued Feb. 8, 2000, utilizes a computerized system and method for creating and managing lease agreements. This patent tracks lease payments, issues lease policies, and provides periodic reports. It also incorporates telecommunication links between lessor computers and the lease control computer.

The Joao (U.S. Pat. No. 6,347,302) Labadorf et al. (Lead Paint Removal: What Insurers Won't Tell You!) and Merritt Editors (How to Insure Your Home) references previously cited by the Examiner in the parent application to preliminarily reject applicant's insurance method discuss insured occupied homeowners and lessee's premises insurance providing coverage for protecting individuals and/or business entities from liability which may arise as the result of excess wear and tear and/or damage which may occur to a leased and/or rented entity during the lease and/or rental term, and further for protecting individuals and/or business entities from liability for post-warranty repairs. The Joao, Labadorf and Merritt insurance products and method rely on an actuarial risk evaluation of dwelling units occupied by the owner or lessee of the unit. The insured was limited to those who actually occupied premises. Previously, it was believed that insured occupied dwelling units were subject to more control and monitoring to minimize risk and losses to the real estate.

Damage exposure for the owner who did not occupy units was thus not included in these homeowner insurance products. Nor was the owner of a multi-unit building covered for the actions of a tenant in his building.

Joao provides an apparatus and a method . . . for providing insurance products, services and/or coverage which provides insurance coverage for protecting individuals and/or business entities from liability which may arise as the result of excess wear and tear and/or damage which may occur to a leased and/or rented entity during the lease and/or rental term, and further for protecting individuals and/or business entities from liability for post-warranty repairs, Col. 2, lines 8-17. As such, it is a named peril type of insurance coverage limited in scope to those perils described (excess wear and tear and/or damage which may occur during the lease and/or rental term). Joao does not teach an machine language database method wherein the type of insurance generated includes coverage to protect the multi-unit dwelling building owner from unintentional damage caused by his tenants from fire, smoke, explosions or water damage, or from negligence injuries caused to third parties, page 13 last paragraph Office Action mailed Mar. 24, 2004 in the parent application Ser. No. 09/921,251. Nor do Labadorf et al. teach this deficiency. Labadorf et al. discusses submittal of claims for lead contamination under all risk types of home owner's insurance policies, see page 2, numbered paragraph 16 discussing the 1973 comprehensive general liability policy.

Nor does the “How to Insure Your Home”, Merritt Publishing, Santa Monica, Calif. publication (Merritt) supply these deficiencies. Merritt discusses standard homeowner's insurance policies for condominium owners. Standard homeowner's insurance provides insurance coverage to the owner occupant of the property in accordance with the terms of the insuring agreement. The Merritt publication thus addresses a particular type of owner occupied insurance, which is not similar to applicant's insurance coverage for the building owner of multi-unit dwellings, such as apartment houses, where the owner most likely will not occupy the premises.

Cited for general interest are: Weatherly et al, U.S. Pat. No. 6,049,784 issued Apr. 11, 2000 and U.S. Pat. No. 6,023,687 issued Feb. 8, 2000 provide predetermined financial information regarding a potential tenant and a potential landlord to a lease control intermediary, and uses computers to evaluate the information to determine the acceptability of the financial risk associated with the potential tenant. It creates a service product in the form of a rent guaranty of periodic lease payments from the lease control intermediary to the landlord. A computer is incorporated into the method for creating and managing the lease agreement, if review of the tenant data falls within acceptable pre-programmed risk levels.

Hough, U.S. Pat. No. 5,414,621 issued May 9, 1995 provides a system and method for computing a comparative value of real estate based on assessment percentages and sales data of comparable properties using a computer and a multiple listing computer database. Information from various building sales is then used to determine “assessed value” and “phase value” based on price/tax factors.

Apgar, IV, U.S. Pat. No. 5,680,305 issued Oct. 21, 1997 provides another system and method for evaluating real estate based on amount, price, area, grade, and risk to provide a scoring rating system to provide a well-rounded picture of a particular real estate situation.

Rothstein, U.S. Pat. No. 6,058,369 issued May 2, 2000 disclosed a method and apparatus for monitoring the strength of a real estate market to make lending and title insurance decisions based upon a derived market index.

The computer system and method described below provides insurance coverage to protect the landlord from negligent unintentional tenant acts causing fire, smoke, explosion and water damage to the building units.

### BRIEF SUMMARY OF THE INVENTION

The invention comprises a computerized system and method to gather, prepare, and maintain sufficient tenant data to enable insurance coverage to be written to cover the building owner from unintentional tenant acts causing fire, smoke, explosion, and water damage, and also at the same time tracking that certain units may opt to cover against these perils with their own HO4 policies rather than renters legal liability insurance. Renters Legal Liability (RLL) insurance covers the building owner from unintentional damage caused by the tenant from fire, explosion, including the explosion of gases or fuel within the furnace of any fired vessel or within the flues or passages through which the gases of combustion pass, not including loss or damage by rupture, bursting or operation of pressure relief devices; or rupture or bursting due to expansion or swelling of the contents of any building structure, caused by or resulting from water, smoke causing sudden and accidental loss or damage not including smoke from agricultural smudging or industrial operations, and water that backs up or overflows from a sewer, drain or sump, and water or other liquids that leak, flow or overflows from plumbing heating air conditioning, or other equipment fixtures, pursuant to predetermined insurability criteria. It may also cover negligence injuries caused by the tenant to third parties pursuant to predetermined insurability criteria. It thus provides building insurance protecting landlords real and personal property from negligent resident damage caused by fire, smoke, explosion, water discharge, and sewer backup.

Prior to this computer system and insurance method, no insurance product provided insurance covering multi-unit dwelling building owners from unintentional damage caused by tenants from fire, smoke, explosions, and water damage, or negligence injuries by the tenant caused to third parties pursuant to predetermined insurability criteria. Nor did these products track the potential that certain units may opt to cover these perils with their own HO4 policies. The renters legal liability (RLL) policy is presently in existence and therefore actually reduced to practice. None of the references cited above present evidence of similar insurance coverage. More importantly, no previous policies similar to the present invention were reduced to practice to anticipate or suggest the invention and insurance method. As a new insurance product and method, there is no previous evidence of prior combinations of references reduced to practice covering similar perils and insurance contract provisions to anticipate or suggest the invention.

Based on the RLL building limits of coverage, the tenant may receive a portion of the RLL surplus proceeds after payment to the owner, which may cover all or a portion of their tenant personal property losses and liability to a third party and damage to the apartment building pursuant to predetermined insurability criteria.

Specifically, the invention comprises a computerized system and method for gathering tenant occupancy and building data at individual tenant unit levels for more accurate risk/cost analysis to insure actuarial compliance for insuring apartments or multi-unit dwelling units with renters legal liability insurance where occupancy and tenant information continually changes for renters liability insurance qualification. This requires on-line computerized input or data exchange from property managers and their existing property management systems. The computerized system comprises a computer processor based automated system combined with software to process data. Data is then entered utilizing automated algorithm based decision making into the computer processor based automated system. In data management, the time scale of the data determines how it is processed and stored. Dynamic data or transactional data is information that is periodically updated, meaning it changes asynchronously over time as new information becomes available.

Data that is not dynamic is considered either static (unchanging) or persistent, which is data that is infrequently accessed and not likely to be modified. Dynamic data is also different from streaming data, which is a constant flow of information. Dynamic data may be updated at any time, with periods of inactivity in between. The present data base is continually changing and relies on periodic computer inputting to insure that the multi-unit or apartment dwelling occupancy coverage meets actuarial renters legal liability insurance requirements. This is particularly true where the number of units in an apartment or dwelling exceeds 200 units and tenant data entry requires speed and algorithm checking to insure compliance.

The databases inputted into the computer processor are:

a. “Building Physical Information” about the apartment complex or multi-unit dwelling complex from all owners and business managers seeking insurance coverage within a geographical area. This information is reviewed and updated monthly, and contains the full name of the insured, the mailing addresses of the units, and the number of buildings. Additional information can be inputted such as the fire insurance policy on the building and building rating by the four basic types of construction recognized in fire insurance coverage—i.e. a Class A building is one with walls, floors, and roof of masonry or concrete, and with all load walls supported by an independent steel frame. A Class B structure is similar to Class A except that interior walls and floors are not constructed of masonry or concrete. A Class C building does not meet all specific requirements of Class B. A Class D building generally refers to frame structures and includes most private residences.

b. “Occupancy Information” about the apartment complex or multi-unit dwelling complex from all owners and business managers seeking insurance coverage within a geographical area specifying the total number of units occupied, and the total number of units vacant at the last reporting period.

c. “Tenant Rental Information” from all owners and business managers and tenants within a geographical area seeking insurance coverage containing the lease agreement requirements, a credit report on the tenant coded to meet legal confidentiality requirements, a criminal background check of the tenant, and a character reference check of the tenant to verify his past tenant conduct.

The above data is preferably received on-line via the internet, or in a variety of media types, including tapes, cartridges, discs, etc. and is integrated with a data integration system to include all relevant data, even though this initially generates redundant entries. Once the building physical information, the occupancy information and the tenant rental information data is entered, it generally doesn't change unless the building is remodeled or the building is damaged.

The other information varies continuously, and has to be periodically updated and inputted to reflect the current rental status and renter identity of each unit. The renter's legal liability coverage (RLL) begins on the date of occupancy and after data has been entered into the computer, and ends as of the date the tenant leaves and is removed from the system. Continuous monitoring insures that empty units are not covered, and that the current tenant is covered as an additional insured. This lowers the overall cost of insurance to the owner by avoiding payment for non-existent insurance coverage on empty units. For example, monthly entries are inputted by each property manager or building owner via an internet screen gathering the necessary information for transmittal through the internet. This information is thus preferably reported on standardized combined or separate interactive computer screens. The first standardized screen, or drop down sub-screen, is the Renters Legal Liability Insurance Management Screen, which will list all of the tenants in the apartment complex. Within this list, the property manager or building owner can view basic unit information as to whether the unit is occupied or vacant, who occupies the unit, when the lease expires, and a summary of insurance coverage. The summary of insurance coverage specifies whether the unit is RLL insured or if the renter has third party renters insurance such as HO-4 policy, and its expiration date. This computer screen is interactive, giving the property manager or building owner the ability to add, edit or delete any of the information pertaining to each unit during the month or reporting period.

Thus, an entry is made for every tenant in the apartment by unit, even though a tenant may occupy several different units. This may result in multiple entries for each tenant, but insures that there is at least one entry per occupied unit. Because the raw data is inputted in a variety of formats and error checking is done when data is inputted, there is no need for extensive personnel training time as to the proper data field inputs and procedures. The system can, therefore, be operated by property leasing personnel utilizing computers connected to the internet to update the system. The employment of property leasing personnel as an arm of the insurance sales force provides participation by persons more sensitive to the needs of their residents, communities, and homes. Thus, insensitive technically correct insurance sales jargon employing such as the terms “renter”, “tenant”, “apartment”, “tenement”, and “complex” is avoided in favor of managers protecting residents' homes. The property leasing personnel are also more familiar with the needs and vocabulary of the multi-unit housing industry, and therefore provide more meaningful and effective RLL product sales.

RLL, unlike other off the shelf products, is specifically designed to cover the multi-unit property owner from tenant liability as a single interest product. Off the shelf products do not allow this provision for the reason that the tenant is the named insured instead of an added insured. As previously stated, as named insured, the building owner is only protecting its interests and as such does not need to be a licensed insurance agent. Contractually tenant agrees to allow landlord to add their unit to the landlord's master policy.

The tenant's rent payment includes the renter's legal liability insurance coverage acquired by the landlord as named insured. The computer automatically adds to the monthly rent bills a surcharge for the added insurance coverage. Thus, the computer program prepares bills via a data sort from the compiled screens. Funds due can then be transferred on line via electronic funds transfers (EFT), Credit Cards, etc.

Other tenants may elect to provide a certificate of their own third party renter's insurance, which also covers their personal property in addition to damage to the unit. A traditional insurance certificate, which names the property owner as an additional insured and/or certificate holder of record is employed for this purpose. This information is then entered into the computer database to enable a building manager or owner to monitor the insurance status of the unit. Alternatively, tracking self-certifying residents can be done by a remote central monitoring group interconnected to access of the system to alleviate the burden on the property owner. The insurance product thus has an endorsement naming the landlord as a certificate holder of record on any policy certificate. This means that in case the policy is cancelled by a tenant, the landlord will have 10 days pre-notification. The building owner would then electronically arrange for RLL coverage and the tenant billed via the system to insure 100% lease compliance. It is contemplated that insurance company credits to the policies covering the property owner's package insurance policy will be available where there is 100% lease compliance. 100% compliance may also make the property owner eligible for a preferred tier rating by participating companies. These participating companies offering credits for 100% lease compliance will be issued RLL certificates. RLL certified companies can advertise on-line on interactive web sites connected to the system where residents can purchase property damage liability waiver coverage. Optional HO-4 form policies may also be offered on-line to residents for qualifying multi-unit complexes, which are covered by RLL insurance. Insurance companies offering traditional HO-4 form policies may also be linked to advertise on the website of participating companies under mutually agreeable terms.

Those ordering the HO-4 policies on-line under the present system may also be able to pay for this insurance as part of the lease payment. The system also enables property owners to charge a billing fee covering administrative expenses in addition to the premium for RLL coverage to provide an additional source of revenue for the building owner.

The insurance carrier generally pre-qualifies the apartment complex or multi-unit dwelling for renter's legal liability insurance via an actuarial assessment computer program inputted into the computer processor that establish the premiums required for each building. This qualification is generally conditioned on periodic updates of the database being provided by the building owner or manager that the occupancy and types of tenants do not materially fall to unacceptable levels. Once the building is pre-qualified, tenant risk will be insured against by renter's legal liability insurance when the tenant rents an apartment or dwelling unit. This renter's legal liability insurance will provide coverage to protect the landlord from unintentional acts of his tenants. RLL coverage is limited to the perils of fire, smoke, explosion and water damage, as well as liability incurred by the tenant so that the coverage can be automatically pre-approved and extended without any independent review triggered by additional risk factors involved in coverages, such as bodily injury. Typically, RLL insurance is capped at the value of the apartment unit, or a pre-set limit. For example, replacement cost as opposed to Actual Cash Value representing the depreciated value of the building in the event of loss could be specified to cover the real property to avoid a financial burden on the building owner in the event of loss. Actual cash value cost would still be specified for the RLL PDLW tenants' personal property to eliminate any financial incentives for the tenants to start a fire to replace worn out personal property.

RLL insurance can be purchased incrementally to only cover units occupied by tenants or on a blanket policy basis covering all of the units in a multi-unit apartment or dwelling. The incremental purchase method progressively covers the entire complex as the units become fully occupied to become a blanket policy. In addition, the insurance actuarial rates per unit may include additional management and commission fees for administering the RLL insurance policy as a cost in the fees charged the owner and tenants for RLL insurance coverage.

) RLL PDLW insurance may also include good neighbor coverage which provides a pre-set limit, such as $1000, for displacement costs for any non-negligent effected tenant and the negligent tenant.

Specifically, the computerized system entry data includes:

i. building physical information,

ii. the number of units in the apartment complex or multi-unit dwelling complex to qualify the complex for coverage,

iii. actuarial insurance rates for renter's legal liability insurance,

iv. lease agreement requirements insuring owners against tenant contract breaches failing to protect the apartment or multi-unit dwelling from losses from resident generated damage caused by fire, smoke, explosion, water discharge, and sewer backup,

v. tenant identity and insurance status of each occupied unit,

vi. insurance carrier actuarial risk assessment pre-qualification requirements of the apartment or multi-unit dwelling for renter's legal liability insurance, and/or RLL PDLW insurance insuring owners against tenant contract breaches failing to protect the apartment or multi-unit dwelling from losses from resident generated damage caused by fire, smoke, explosion, water discharge, and sewer backup,

vii. frequency review requirements for updates of the database regarding building occupancy and types of tenants to maintain pre-qualification status,

viii. the identity of the insured non-occupying building owner and/or property manager of an apartment of multi-unit dwelling, and

ix. internal data sets of pre-qualification unit level requirements for the apartment or multi-unit dwelling to verify eligibility of renters legal liability insurance via a qualifying matching algorithm that compares the remote input from the property manager or their property management system.

In addition, the insurance status of each tenant is stored and tracked by monitoring the insurance carrier actuarial risk pre-qualification requirements and insuring that pre-qualifications are maintained during operations of the apartment or multi-unit dwelling.

Another system module has an algorithm that calculates replacement cost rates based on the number of insured units, and a percentage of the insured units additionally covered by third party insurance so that the RLL coverage is written on a group rate. This provides universal, capped, add-on single interest insurance coverage insuring owners against unintentional tenant contract breaches failing to protect the apartment or multi-unit dwelling from losses from resident generated damage caused by fire, smoke, explosion, water discharge, and sewer backup.

The building physical information may comprise the full name of the insured, the mailing addresses of the building units, the number of buildings and units, the fire insurance policy on the building and rating by the four basic types of construction recognized in fire insurance coverage and including building owner coverage for negligence injuries by the tenant caused to third parties.

The database may include a credit report on the tenant coded to meet legal confidentiality requirements, a criminal background check of the tenant, and a character reference check of the tenant to verify his past tenant conduct.

In addition, the data base may include adding commission and management fees to the actuarial insurance rates for inclusion in the billings of the owner.

Inputting of the building physical information, relevant information, and tenant rental information is usually inputted monthly.

In one embodiment the computer system data entry will receive all the coverage data (unit information, such as occupancy, insurance type, coverage dates, etc.). In this scenario the system will leverage the users time by pulling the coverage data at least daily from the PMS (Property Management System). There are many different popular PMS products in use to help with the property management functions. Example of these tracking functions are: Tenant portal, Repair/maintenance ticket tracking, Rental sales support, New resident move in and move out. The RLL computer system has a natural integration point in the PMS lifecycle. A new resident move-in is a common action. Here the property manager will indicate if the resident will use their own third party renter's policy or if they will choose to waive their right and instead participate in the RLL program. Most popular PMS systems will have a screen for the property manager to enter their renter policy data. If the resident will choose the RLL program then there is an integration strategy for each PMS. In some cases, the property manager would enter “RLL” where the renters policy company name would go. In this example, the RLL importer capability would pull data from the PMS at least daily and if/when a resident with “RLL” is indicated, then the importer system will process this coverage automatically for that unit. Thus that unit will be covered by the RLL program and will remain covered until the resident moves out or if the resident decides to exercise their right to use instead their qualified renter's policy. When the changes happen, the RLL importer will pull all the units' data and spot those that require a coverage change.

There are many complex variations to the integration example above. In some cases the integration potential of the PMS can be very restrictive. As example, some PMS systems can at best allow a report to be created in the form of an excel file or (comma delimited file). In this case the property manage may have to email the daily file to a dedicated RLL email address. In this case the importer has a feature to automatically scan and seek and inbound emails. It will automatically process the file and pull out the units with a coverage change. In some cases the importer logic will be required to read related information for the RLL designated unit to determine if a coverage change is needed and if so what type. It could be a move-out and thus canceling the RLL program effective the move-out date. It could be that as the importer reviews the unit data, it sees changes from what was stored from the prior day. For example, it may find that the unit now shows a resident policy.

There is also a subsystem of the importer that will look for resident policy expiration with the intention of converting the unit back to RLL program thus reducing the risk of a lapse in coverage. As example, if the residents renter policy expires and the property manager does not change the unit to the RLL program and there is a fire.

For insurance verification, notices requesting insurance verification to uninsured tenants are mailed and the information inputted to update the working database with the uninsured tenants' replies to the notices.

Trend report summaries of the status of uninsured tenants may also be computer generated and transmitted to authorized parties.

In another embodiment, the computer system data base includes:
i. the full name of the insured
ii. the mailing addresses of the building units,
iii. the number of buildings and units,
iv. the fire insurance policy on the building and rating by the four basic types of construction: a) Class A buildings with walls, floors, and roof of masonry or concrete with all load walls supported by an independent steel frame, b) Class B similar to Class A except that interior walls and floors are not constructed of masonry or concrete, c) Class C building does not meet all specific requirements of Class B, and d) Class D building generally referring to frame structures recognized in fire insurance coverage,
v. actuarial insurance rates for renter's legal liability insurance,
vi. tenant rental information, which includes lease agreement requirements insuring owners against tenant contract breaches failing to protect the apartment or multi-unit dwelling from losses from resident generated damage caused by fire, smoke, explosion, water discharge, and sewer backup,
vii. limits of coverage,
viii. a credit report on the tenant coded to meet legal confidentiality requirements,
ix. a criminal background check of the tenant,
x. a character reference check of the tenant to verify past tenant conduct,
xi. tenant identity and insurance status of each occupied unit, and
xii. insurance carrier actuarial risk assessment pre-qualification requirements of the apartment or multi-unit dwelling for renter's legal liability insurance, and/or RLL PDLW insurance insuring owners against tenant contract breaches failing to protect the apartment or multi-unit dwelling from losses from resident generated damage caused by fire, smoke, explosion, water discharge, and sewer backup.

To process this information, a software module containing algorithms for generating a property damage liability waiver (PDLW) insurance coverage for the tenant may be included, which provides a pre-set amount of coverage for displaced tenants, and an additional sum for living expenses to the tenant unintentionally causing damage to the dwelling unit.

The renter's legal liability insurance usually covers the building owner's property for replacement cost.

Another system module will issue a renters legal liability single interest insurance policy to the non-occupying building owner covering the non-occupying building owner and/or property manager of a qualified apartment of multi-unit dwelling as the named insured from unintentional contract breach damages cause by the tenant from losses from resident generated damage caused by fire, smoke, explosion, water discharge, and sewer backup at a rate based on the number of insured units.

It also may include a program to bill the owner for the renter's legal liability insurance coverage.

The computer system may generate renters legal liability insurance with PDLW coverage limits, which covers both the owner and possibly the tenant's personal property within the unit.

To assist in data entry, the computer system may include providing on-line real time computer display access to tenants to purchase either renters legal liability or RLL PDLW insurance coverage.

The computerized method is for gathering tenant occupancy and building data at individual tenant unit levels for more accurate risk/cost analysis to insure actuarial compliance for insuring apartments or multi-unit dwelling units with renters legal liability insurance where occupancy and tenant information continually changes for renters liability insurance qualification requiring on-line computerized input or data exchange from property managers and their existing property management systems.

It comprises entering data utilized for automated algorithm based decision making into a computer processor based automated system, which includes:

i. building physical information,

ii. the number of units in the apartment complex or multi-unit dwelling complex to qualify the complex for coverage,

iii. actuarial insurance rates for renter's legal liability insurance,

iv. lease agreement requirements insuring owners against tenant contract breaches failing to protect the apartment or multi-unit dwelling from losses from resident generated damage caused by fire, smoke, explosion, water discharge, and sewer backup,

v. tenant identity and insurance status of each occupied unit,

vi. insurance carrier actuarial risk assessment pre-qualification requirements of the apartment or multi-unit dwelling for renter's legal liability insurance, and/or RLL PDLW insurance insuring owners against tenant contract breaches failing to protect the apartment or multi-unit dwelling from losses from resident generated damage caused by fire, smoke, explosion, water discharge, and sewer backup,

vii. frequency review requirements for updates of the database regarding building occupancy and types of tenants to maintain pre-qualification status, and

viii. the identity of the insured non-occupying building owner and/or property manager of an apartment of multi-unit dwelling.

The data base also includes internal data sets of pre-qualification unit level requirements for the apartment or multi-unit dwelling to verify eligibility of renters legal liability insurance via a qualifying matching algorithm that compares the remote input from the property manager or their property management system.

The computerized method then stores and tracks the insurance status of each tenant by monitoring the insurance carrier actuarial risk pre-qualification requirements and insuring that the pre-qualifications are maintained during operations of the apartment or multi-unit dwelling.

It then generates by a second computer processor using programming language replacement cost rates based on the number of insured units, and a percentage of the insured units additionally covered by property damage liability waivers. RLL is thus written on a group rate providing universal, capped, add-on single interest insurance coverage insuring owners against unintentional tenant contract breaches failing to protect the apartment or multi-unit dwelling from losses from resident generated damage caused by fire, smoke, explosion, water discharge, and sewer backup.

The computer method often has the inputted data looped to compare it with renters legal liability qualification data stored in the database for compliance using software modules with contained algorithms.

In one variation, the computer method data includes:

i. the full name of the insured,

ii. the mailing addresses of the building units,

iii. the number of buildings and units,

iv. the fire insurance policy on the building and rating by the four basic types of construction: a) Class A buildings with walls, floors, and roof of masonry or concrete with all load walls supported by an independent steel frame, b) Class B similar to Class A except that interior walls and floors are not constructed of masonry or concrete, c) Class C building does not meet all specific requirements of Class B, and d) Class D building generally referring to frame structures recognized in fire insurance coverage,

v. actuarial insurance rates for renter's legal liability insurance,

vi. tenant rental information, which includes lease agreement requirements insuring owners against tenant contract breaches failing to protect the apartment or multi-unit dwelling from losses from resident generated damage caused by fire, smoke, explosion, water discharge, and sewer backup,

vii. limits of coverage,

viii. a credit report on the tenant coded to meet legal confidentiality requirements,

ix. a criminal background check of the tenant,

x. a character reference check of the tenant to verify past tenant conduct,

xi. tenant identity and insurance status of each occupied unit,

xii. tenant identity and insurance status of each occupied unit, and

xiii. insurance carrier actuarial risk assessment pre-qualification requirements of the apartment or multi-unit dwelling for renter's legal liability insurance, and/or RLL PDLW insurance coverage insuring owners against tenant contract breaches failing to protect the apartment or multi-unit dwelling from losses from resident generated damage caused by fire, smoke, explosion, water discharge, and sewer backup.

This data may then be entry and error checked to match the tangible non-transitory memory database when data is inputted to insure there is one entry record per unit.

Maintaining pre-qualifications of the apartment or multi-unit dwelling to be eligible for renters legal liability insurance is made by a system module that periodically monitors tenant data to evaluate the insurance status of each tenant by comparing the insurance carrier actuarial risk pre-qualification requirements and insuring that the pre-qualifications are maintained during operations of the apartment or multi-unit dwelling. It also provides a replacement cost rate based for renters legal liability insurance based on i) the building physical information and the number of insured units in the complex, ii) the limits of coverage, and iii) a percentage of the insured units additionally covered by third party renters insurance. RLL is written on a group rate based on large numbers providing universal, capped, add-on insurance coverage to occupants of the entire apartment or multi-unit dwelling for renters legal liability single interest insurance policy.

The computer method produces the renter's legal liability insurance policy in a permanent written or unalterable media embodiment listing the coverage provided covering the unit. The renter's legal liability insurance policy may include additional property damage liability waiver insurance coverage, which also covers the tenant's personal property up to predetermined limits in addition to damage to the unit.

The computer method RLL PDLW insurance coverage policy allows the tenant to acquire coverage by paying an additional insurance premium as part of the unit rent.

In another variation, the computer system comprises:

updated computer system with data structures containing:

i. non-occupying owner and building physical information about the apartment complex or multi-unit dwelling and number of units to qualify the complex for fire insurance coverage,

ii. tenant data including lease agreement requirements insuring owners against tenant contract breaches failing to protect the apartment or multi-unit dwelling from losses from resident generated damage caused by fire, smoke, explosion, water discharge, and sewer backup to qualify the complex or multi-unit dwelling for renter's legal liability insurance coverage,

iii. actuarial insurance rates for renter's legal liability insurance, and other relevant information,

iv. tenant identity and insurance status of each occupied unit, and

v. insurance carrier actuarial risk assessment pre-qualification requirements of the apartment or multi-unit dwelling for renter's legal liability insurance, and/or RLL PDLW insurance insuring owners against tenant contract breaches failing to protect the apartment or multi-unit dwelling from losses from resident generated damage caused by fire, smoke, explosion, water discharge, and sewer backup.

It also includes computer system module associated algorithms for:

i. insuring the accuracy of the database by repeatedly sorting the database by building address to create a working database of the insurance status of each tenant,

ii. maintaining pre-qualification of the apartment or multi-unit dwelling for renters legal liability insurance by periodically monitoring the insurance carrier pre-qualifications and insuring that the pre-qualifications are maintained during operations of the apartment or multi-unit dwelling, and

iii. generating a base replacement cost rate charge for the renters legal liability insurance single interest insurance coverage insuring owners against unintentional tenant contract breaches failing to protect the apartment or multi-unit dwelling from losses from resident generated damage caused by fire, smoke, explosion, water discharge, and sewer backup based on the building physical information and number of units in the complex, and a percentage of the insured units in the apartment or multi-unit-dwelling additionally covered by third party renters insurance, both written on a group rate providing universal, capped, add-on insurance coverage of occupants of the entire apartment or multi-unit dwelling.

A system module is also included to generate renters legal liability single interest insurance policy coverage insuring owners against unintentional tenant contract breaches failing to protect the apartment or multi-unit dwelling from losses from resident generated damage caused by fire, smoke, explosion, water discharge, and sewer backup; and optional RLL PDLW insurance coverage for the tenant. RLL PDLW provides a pre-set amount of coverage for displaced tenants, and an additional sum for living expenses to the tenant unintentionally causing damage to the dwelling unit. It then issues renters legal liability single interest insurance in a permanent unalterable media embodiment to the non-occupying owners as the named insured listing the coverage provided covering the complex or multi-unit dwelling. The system module also bills the non-occupying owner and/or property manager for renters legal liability insurance coverage.

An interactive display terminal is operably associated with and activated by the system module adapted or configured to display insurance rates and allow interested parties to purchase renters legal liability insurance.

The renters legal liability insurance protects the landowner from unintentional damage caused by the tenant from two or more the perils selected from the group comprising fire, smoke, explosion, including the explosion of gases or fuel within the furnace of any fired vessel or within the flues or passages through which the gases of combustion pass and water that backs up or overflows from a sewer, drain or sump, and water or other liquids that leak, flow or overflows from plumbing heating air conditioning, or other equipment fixtures, and negligence injuries by the tenant caused to third parties pursuant to predetermined insurability criteria.

Alternatively, the renters liability insurance protects the owner from unintentional damage caused by the tenant from three or more or four or more perils.

The above computer system and method thus enables issuing RLL insurance meeting the needs of both the tenant and building owner with insurance unique as to the time coverage begins and ends. It also generates insurance leads as to additional insurance through non-insurance personnel who are not paid a commission or salary. More importantly, it makes available a new insurance product covering the landlord based on continual computer monitoring of the tenant insurance status of a multi-unit dwelling complex. It is not an off the shelf product requiring a comprehensive insurance sales license for sales and distributions. Instead, it is a limited coverage product pre-approved by state licensing authorities, which covers the building, and, if needed, can be sold under a limited insurance sales license.

The computer system and method also provide a social benefit to the community in that an insurance remedy is offered instead of having to rely on community charitable resources, such as the Red Cross, when a large apartment fire occurs, keeping in mind that approximately 90% of the renter's in the United States are currently uninsured.

### BRIEF DESCRIPTION OF THE SEVERAL VIEWS OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a schematic flow diagram of a preferred method and apparatus.

FIG. 2 illustrates a sample Renter's Legal Liability and Tenant Occupancy Computer Screen.

FIGS. 3 through 6 illustrate a series of flowcharts of a method for issuing RLL insurance using RLL Administration.

FIG. 7 illustrates a log in screen.

FIG. 8 illustrates a RLL Administration screen.

FIG. 9 illustrates a User List screen.

FIG. 10 illustrates an Add User screen.

FIG. 11 illustrates an Apartment List screen.

FIG. 12 illustrates an overview of the RLL computer system.

### DETAILED DESCRIPTION OF THE INVENTION

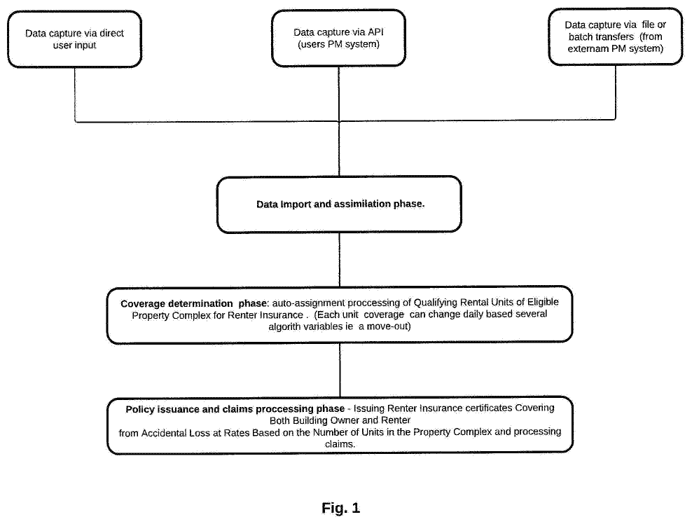

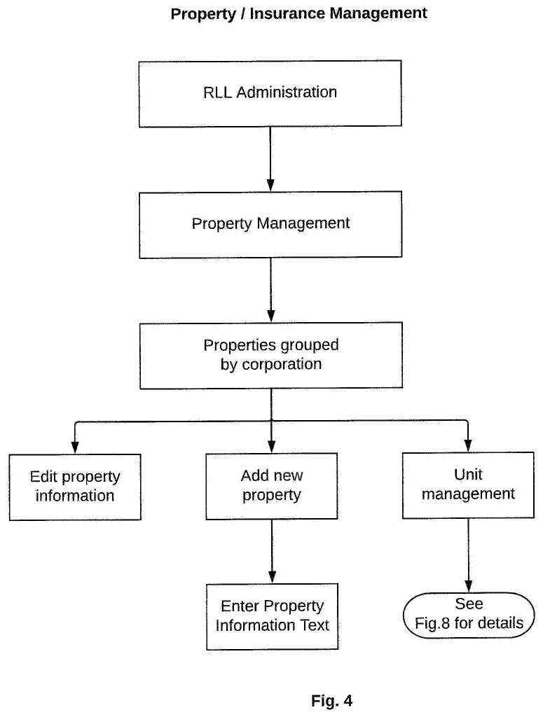

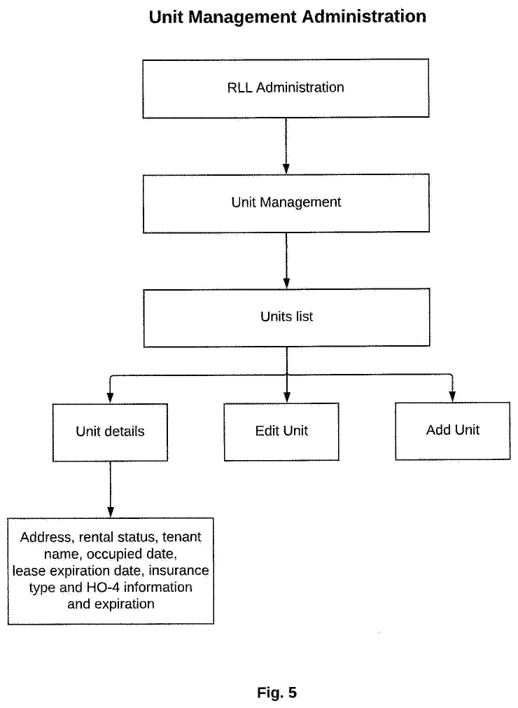

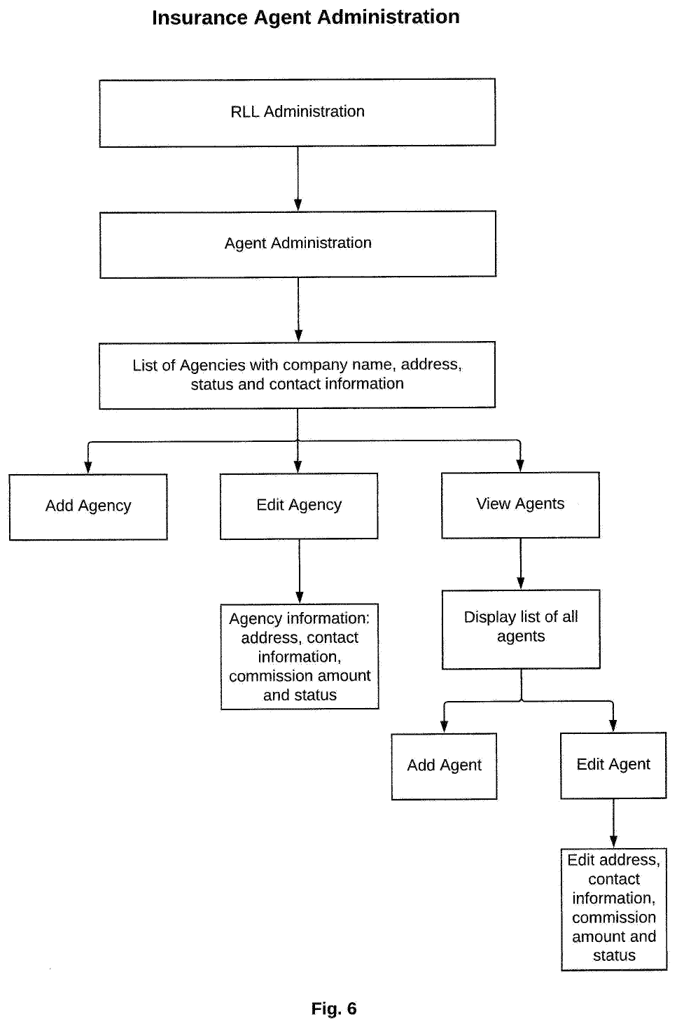

Examples of the embodiments of the present invention are shown in the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the Method and Apparatus of the present invention, as represented in FIGS. 1 through 12, is not intended to limit the scope of the invention, as claimed, but is merely representative of presently preferred embodiments of the invention.

FIG. 1 illustrates a schematic flow diagram of the basic preferred overall method. The first phase of the computer method comprises the data capture phase which has three approaches depending upon the buildings existing property management systems (PMS): 1) Direct data entry to the RLL system by the building manager, 2) API transfer established between the RLL system and the building PMS software, 3) batch transfer of an exported file from the PMS system. The data captured includes relevant building physical information, occupancy information, and tenant rental information.

The second phase of the system involves importing and assimilating the data into an RLL standard format. There are a multitude of potential import formats this phase ensures that all of the captured data is formatted properly in preparation for the coverage assignment or update phase

The third phase of the system is the coverage auto-assignment phase. An insurance qualification procedure is executed to qualify the property for tenant insurance, and establish the periodic premiums for payment by the tenant. In some cases, a property may be qualified by default without going through the qualification process procedures. In addition this phase will determine coverage for each individual unit based on the unit data captured.

The fourth phase of the system is the coverage determination phase. The auto-assignment process will use heuristics to determine the intended coverage. A simple example is the determination that a move-out or vacancy occurred from this capture. Thus the system will automatically end the RLL policy and trigger a prorated charge. Many other scenarios exist. Because of the sheer volume of data captured, it is not possible to contact a property to determine or clarify the coverage intention.

The fifth phase of the system is the Policy issuance and claims processing phase. The system generates policy certificates and process claims. From the uninsured tenant lists, the building owner or manager can take appropriate steps to enforce the lease provisions requiring tenant insurance coverage.

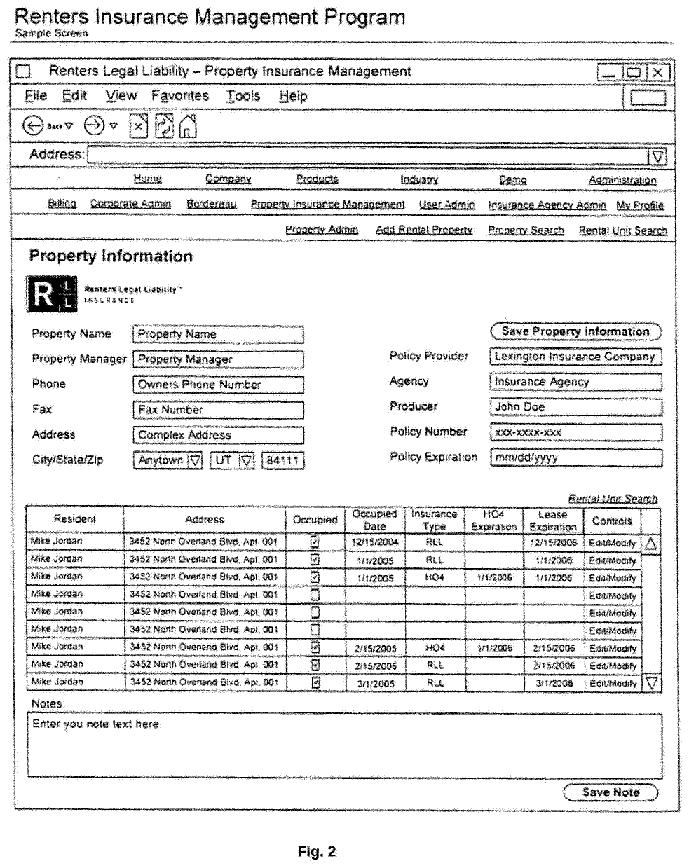

FIG. 2 illustrates a screen for a building and the associated units. The Screen has drop-down interactive sub-screens for listing all of the tenants in the apartment complex, the tenants that have purchased insurance through the apartment complex over the basic renter's legal liability coverage, the tenants that have provided their own insurance through other means, and those units not currently occupied. Generally, these interactive screens gather the relevant building physical information, such as the full name of the insured, the mailing addresses of the building units, the number of buildings, the fire insurance policy on the building and rating by the four basic types of construction recognized in fire insurance coverage. They may also gather the date the building was constructed, the protection class, number of fire hydrants, prior loss information as to liability and property claims, and any updating of the buildings, such as the installation of circuit breakers, wiring, roof replacement, plumbing up-grades, and heating and air conditioning replacement. In addition, the number of buildings in the complex, the units per building, and the units currently occupied in each building, may be in-putted.

The relevant occupancy information generally includes the total number of units occupied, and the total number of units vacant at the last reporting period. It may also include the building tenant's age, date of birth, marital status, type and length of employment, credit and criminal background checks, previous residence location, and prior losses. This information is then electronically transmitted to a large insurance database on a global information network.

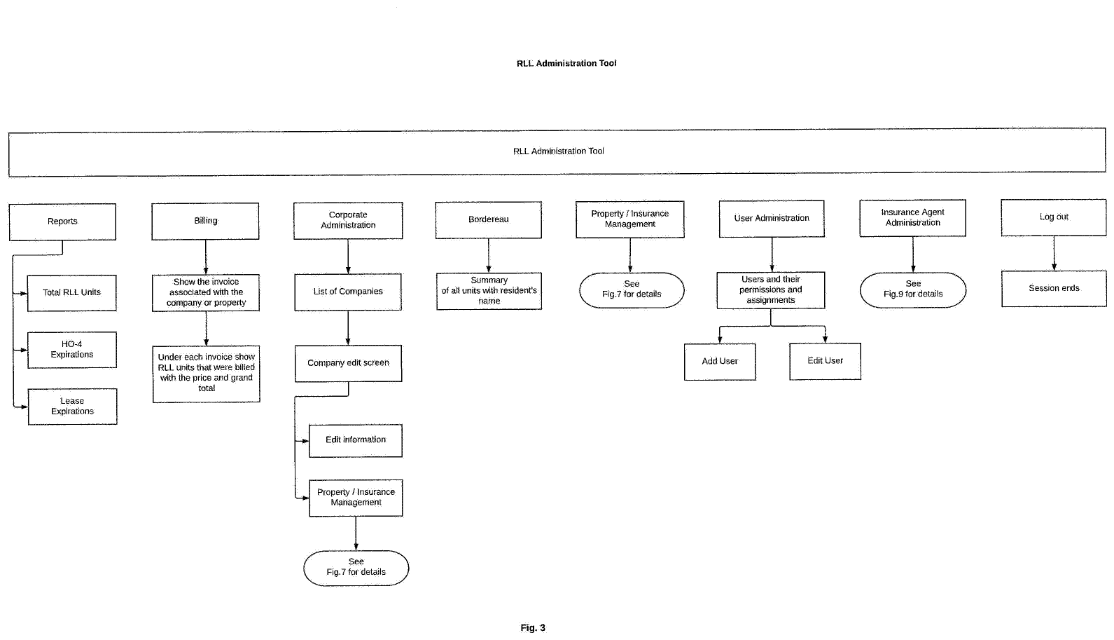

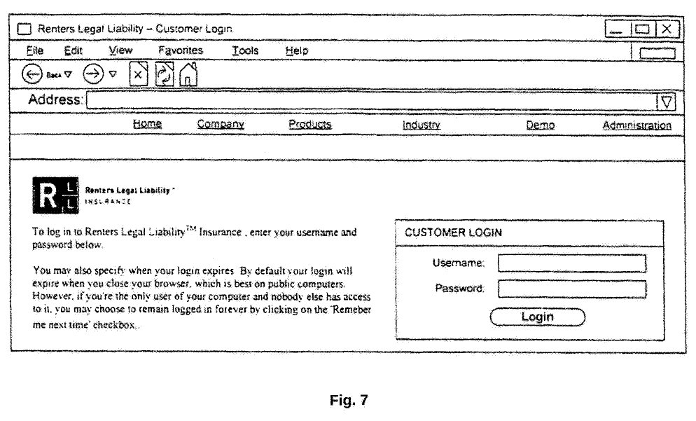

FIGS. 3 through 6 are a series of flowcharts illustrating an example of a method for purchasing and issuing RLL insurance using a copyrighted software program entitled “RLL Administration” produced by Monitoring Computerized Services of Salt Lake City, Utah. To enter the RLL Administration website, the user will log in and be forwarded to a main page. From there he/she can access administration pages. The website will be laid out in a very simple format to allow easy navigation and maintenance and fast download times with the ability to customize the look and feel as shown in the log in screen of FIG. 7, for example.

) Once users log in, they are connected to RLL Administration depending on the permissions preset for the user. If a user is an administrator, he/she will be forwarded to the administrator section. If the user is a corporate manager, he/she will be forwarded over to the corporate manager section, etc.

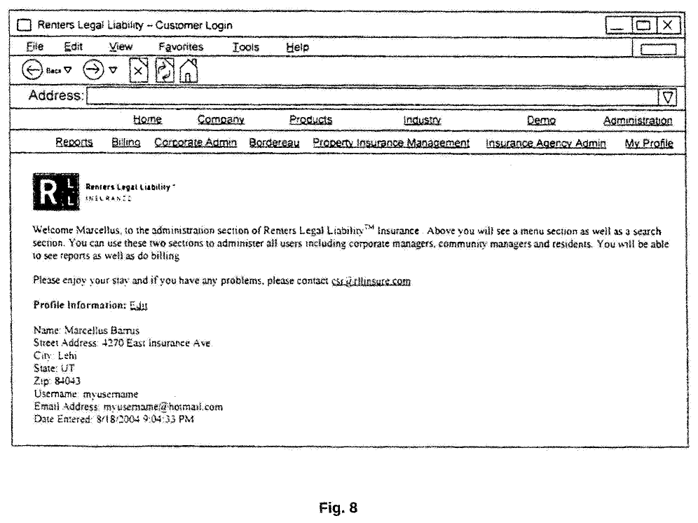

The Super Administration area is where the administrators of RLL will go to administer all users within the RLL network. Different menus or portlets are available depending on a user's permissions as shown in the RLL Administration screen, FIG. 8, for an example of the administration sub-menu.

The administration menu gives the administrator access to the needed screens. An administrator can view reports, billing information, business information of property owners and their properties, insurance management of the individual properties, user administration, agencies and the current user's profile. Through this menu system an individual administrator can update, view and maintain all aspects of the RLL Website.

Within the reports section the RLL administrator can view specific reports concerning RLL clients such as upcoming HO-4 expirations, upcoming lease expirations and current agent commissions. Additional reports such as how many users are active can also be available.

Within the billing section, the administrator can view the month-to-date summary of the amount to be billed within the specified month of all the units that are currently insured through the RLL system. The month-to-date summary is broken down by categories: the Property Owner, the different property names, and the number of units with each property. Past billing reports can also be pulled up within this area to allow the administrator to report of all billing activities that have previously occurred. The process of doing the billing does not happen through the RLL website. The website is used only to gather billing information. Once a month, the current billing information is gathered and sent to the RLL billing department. The billing process can be accomplished automatically through the functionality of the operating system.

At the beginning of every month, a billing invoice is sent to each property owner and property manager notifying them of their current billing status to allow the ability to fix any discrepancies with their insured units within the Renters Legal Liability system. When an individual is entered in the first time, the monthly bill can be prorated and will be billed the following month. So, the first time an individual will be billed will take place the second month of activity with a partial bill for the partial month of activity plus the current month's bill. There are three applications that run on the server machine that run as scheduled programs once a month. The first has been code named ‘Billing Invoice’. This application runs through the billing history and notifies the property manager or owner of the current monthly bill. If there are any problems with this invoice, the property manager or owner has the ability to make the changes that are needed before the billing actually takes place.

The second application has been code named ‘Billing History’. This application runs the billing history. The data received from this application is live data for billing reports as well as what information is sent to the billing department.

The third application has been code named ‘Billing Batch’. The ‘Billing Batch’ application pulls all the appropriate billing information for that month from the database that the ‘Billing History’ application stored. Once this information is gathered, it is sent over the billing department to be billed.

Corporate administration gives the RLL administrator the go ahead to search for the different property owners and update their individual information. Information such as their contact data, phone numbers, addresses, billing information and information on their different properties can be changed or updated. Search functionality is built into the corporate administration for quick lookup of hard to find information. Property owner information can also be added in this area.

A bordereau report is also accessible through the administration area. A bordereau report is a report that displays all currently insured units and their occupants. This report is sent via e-mail to the covering insurance underwriter monthly.

Within the Property Management area, the administration user can go into all properties to manage information such as property address location, contact numbers, property manager and tenant information. Additional administration features can be accomplished through this area as well, such as adding rental units to specific properties, adding and searching for specific tenants, adding and modifying tenant insurance information that deals specifically with the RLL insurance policy or HO-4 insurance policy. This administration area is also available to property owners and property managers.

The user administration section gives the administrator abilities to search, edit and add users. The administrator has the ability search by user type or last name, email address, company name, or username. One can sort users in alphabetical order as well. Once the user is found within the system, the administrator has the ability to edit or modify the user. When editing the user, the administration can change information such as name and company, address, contact information, permissions and properties managed if they are a property manager. Once changes are made the RLL system is updated immediately.

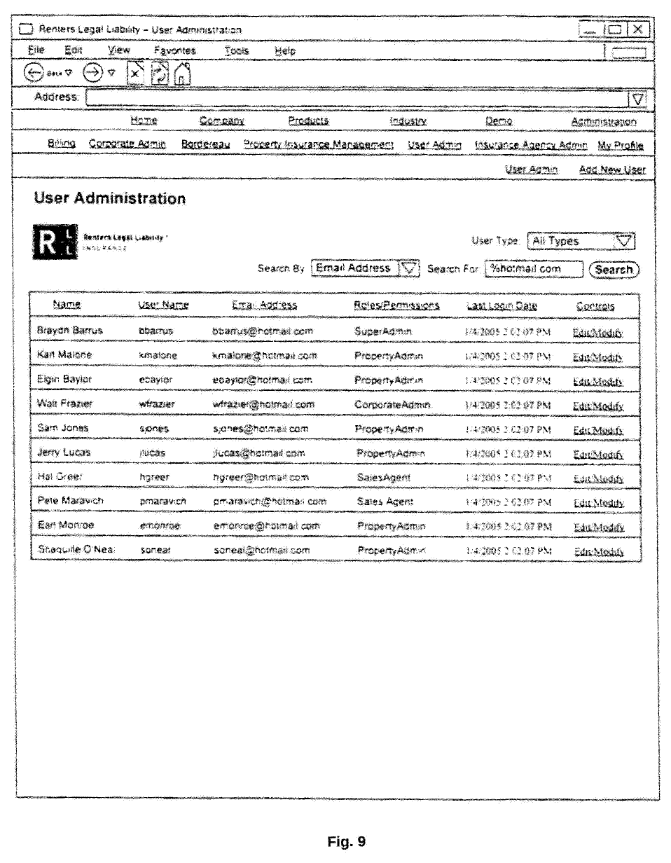

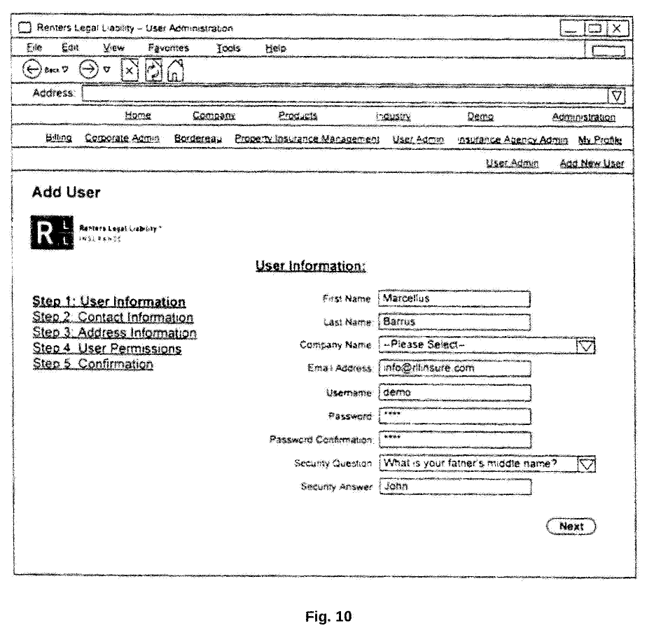

At the top of every screen within the user administration, as shown in the User List Screen, FIG. 9, the user has the option of adding new users no matter what their type through the user administration sub menu. If a user is a corporate or community manager, the administrator will be able to drill down to their level and administer information specific to their communities. To add a user the following information should be entered: user type, first name, last name, email address, company name, business phone number, business fax and shipping and mailing addresses as shown in the Add User Screen, FIG. 10, for example. Once this information is entered and the submit button is pressed, the user is added to the database. If the user permissions have been set on initial signup, the user immediately has access to this site and can immediately start administrating communities or residents.

The ‘Corporate Administration’ and the ‘Property Administration’ areas are very similar to the ‘Super Administration’ area except that the corporate administrator only has access to his specific information. Depending on the permissions that have been set by the super administrator, the corporate administrator can add communities, search users, view billing information (not do billing), and view and modify residents if required. Searching capabilities will also be given to the corporate administrator but will be limited only to users that have been granted access by the super administrator.

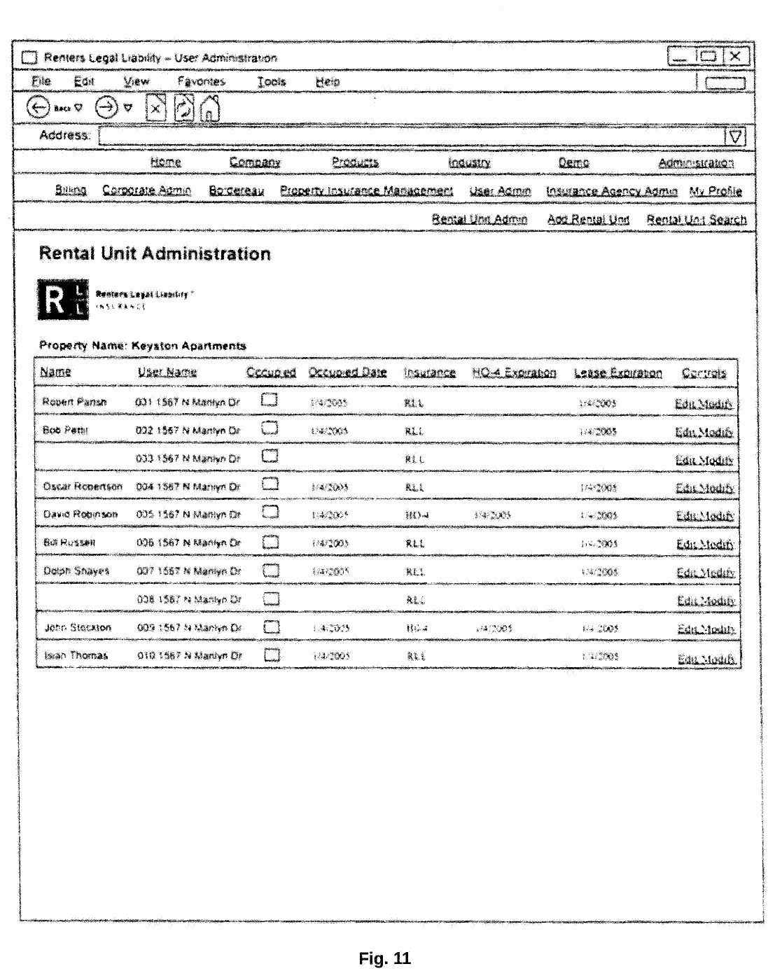

The property manager has the ability to add buildings to his community and residents to those buildings. The Apartment List Screen of FIG. 11 comes from the corporate administration section and depicts the capability to accomplish all required functions within the community. The property manager has the ability to update rental information and assign residents to those units. Property manager has the ability to add each resident to the Renter Legal Liability insurance policy. Thus, allowing each resident to have insurance.

Resident information is managed through the property management area. Information such as when the lease expires, if the resident has an HO-4 or the unit is covered by RLL insurance. If the resident has an HO-4, the HO-4 expiration will be available to add or update. This information will be used for reporting and billing information and will be accessible only to the super administrator, the corporate administrator and the community manager. Once a resident has been registered with the RLL system, a printed certificate can be given to the resident stating that insurance has been obtained through the RLL administrator. The super administrator, corporate administrator, community manager or the resident himself can pull up the certificate at any time. Also, at the conclusion of registration, the resident can confidently state that renter's legal liability insurance has been purchased.

Renters Legal Liability is a fully functional website monitored by Monitoring Computerized Services (MCS) of Salt Lake City, Utah to allow the RLL administrator the ability to easily administer rental insurance for owners and property managers. MCS has selected the Microsoft Windows Server 2003 with the Microsoft Internet Information Server (IIS) software to power the web site and the backend applications. IIS serves web pages for the RLL web site. IIS web server that is easily extendable to allow rapid customization to fit a specific profile of an individual company.

ASP.Net is the programming technology using the C # programming language. Because of the extendibility of IIS, ASP.Net can be compiled into it as a module to work as one. This allows a web site using the ASP.Net technology to run more smoothly and efficiently. Also, because the ASP.Net is being used as the programming technology, the RLL system isn't limited to using C # as its main programming language. Other languages compatible with the ASP.Net technology can be used, such as C++, C, Visual Basic.Net, Python and Perl.

Microsoft SQL Server is the backend database server. Microsoft SQL Server has the capability to process millions of records without degradation. It complies with most of the SQL92 and SQL99 specifications providing an easy migration to other databases if required.

Web Site Hardware

HP servers are examples of preferred web site hardware. To accommodate growth and web site reliability, the web site hardware may be partitioned into phases as business expands. Initially, MCS has only documented phase one hardware and will define phase two and three as appropriate. The present preferred hardware comprises:

HP LP 2000r

4-120 Gig Hardrive

1—Raid Scsii Controller (NetRaid 4)

2—10/100/1000 BaseT NIC

2—Gig Memory

1—Video Card

1—DVD-ROM

1—DDS3

2—3.2 mhz Processors

2—Power Supplies

Rack Mounted

Windows 20003 Server OS

Web Site Hosting

Web hosting is facilitated by VIA West in Salt Lake City. VIA West specializes in delivering quality broadband access, shared and dedicated server-hosting, collocation and managed services consulting to small and medium-sized businesses.

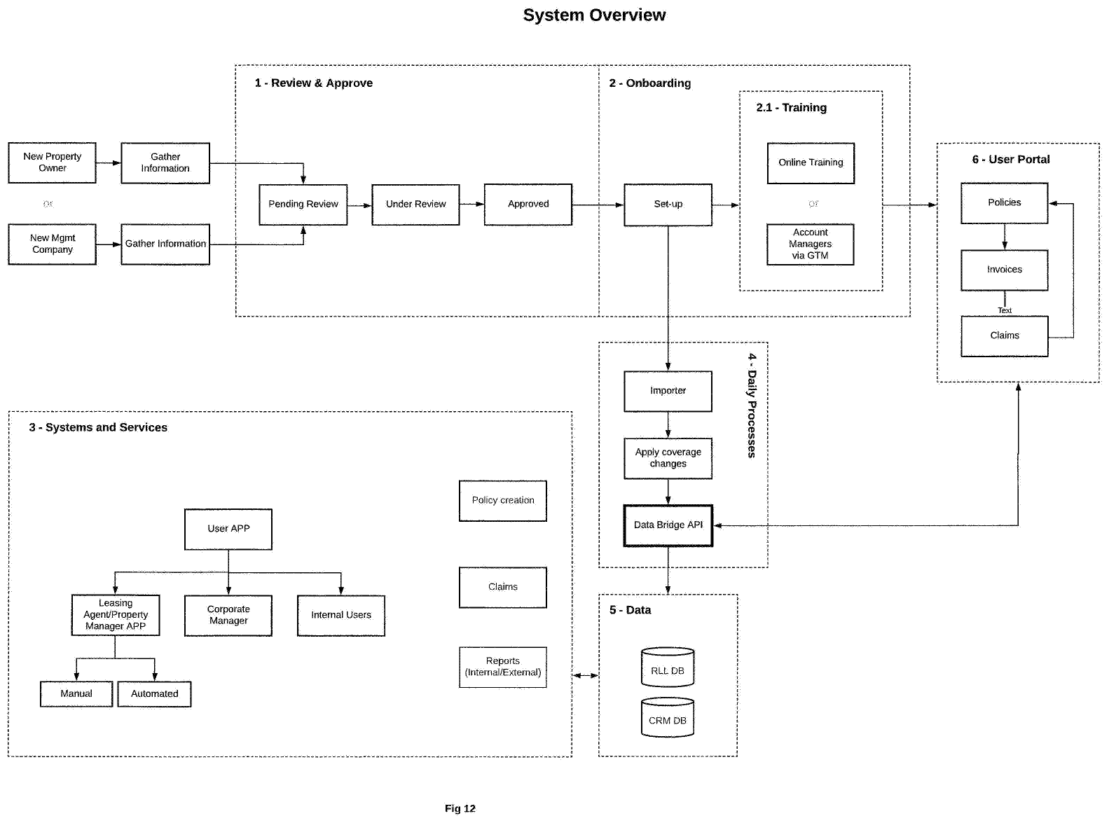

FIG. 12 illustrates a summary of the full system.

Item 1 begins the process. All property data is inputted either from the property owner or their designated property management company. The system tracks the approval status of each submission. Once all the submission data is confirmed, it's then compared to the acceptance criteria. It the property meets the criteria, then the property is flagged as approved by the system.

Item 2 Onboarding—once a property is approved then onboarding begins. The set-up step assures the users integration to RLL is activated properly. Integration methods include direct data entry, daily file submission or API. Once the setup is completed, then the property management staff is invited and required to take online training. Once users pass the online training quiz, then onboarding is completed.

Item 3 illustrates the core subsystems. These subsystems are event based. Users App to manage updates, policy creation, claims and reporting.

Item 4 illustrates the daily processing, which is the heart of the system where each day every property and every unit is checked (via external interface) for potential changes in coverage. As an example, the residents own renters policy expires and they elect the RLL PDLW waiver based coverage.

Item 5 illustrates the data storage. All the data sets are stored secured and organized for easy access to the system modules and sub-system functions.

Item 6 illustrates the external user portal. The portal is used to distribute reports, policies and invoices in a secure manor. The external users receives a notification of a new item to view or download.

) The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

We claim:

1. A computer system for gathering tenant occupancy and building data at individual tenant unit levels for more accurate risk/cost analysis to insure actuarial compliance for insuring apartments or multi-unit dwelling units with renters legal liability insurance where occupancy and tenant information continually changes for renters liability insurance qualification requiring on-line computerized input or data exchange from property managers and their existing property management systems comprising:
a. a computer processor based automated system combined with software to process data,
b. a data entry system entering data utilizing automated algorithm based decision making for entry into the computer processor based automated system, which includes:
i. building physical information,
ii. the number of units in the apartment complex or multi-unit dwelling complex to qualify the complex for coverage,
iii. actuarial insurance rates for renter's legal liability insurance,
iv. lease agreement requirements insuring owners against tenant contract breaches failing to protect the apartment or multi-unit dwelling from losses from resident generated damage caused by fire, smoke, explosion, water discharge, and sewer backup,
v. tenant identity and insurance status of each occupied unit,
vi. insurance carrier actuarial risk assessment pre-qualification requirements of the apartment or multi-unit dwelling for renter's legal liability insurance, and/or property damage liability waiver (RLL PDLW) insurance insuring owners against tenant contract breaches failing to protect the apartment or multi-unit dwelling from losses from resident generated damage caused by fire, smoke, explosion, water discharge, and sewer backup,
vii. frequency review requirements for updates of the database regarding building occupancy and types of tenants to maintain pre-qualification status,
viii. the identity of the insured non-occupying building owner and/or property manager of an apartment of multi-unit dwelling, and
ix. internal data sets of pre-qualification unit level requirements for the apartment or multi-unit dwelling to verify eligibility of renters legal liability insurance via a qualifying matching algorithm that compares the remote input from the property manager or their property management system,
c. a storage component storing and tracking the insurance status of each tenant by monitoring the insurance carrier actuarial risk pre-qualification requirements and insuring that pre-qualifications are maintained during operations of the apartment or multi-unit dwelling; and
d. a system module generating replacement cost rates based on the number of insured units, and a percentage of the insured units additionally covered by third party renters insurance, and issuing renters legal liability insurance written on a group rate providing universal, capped, add-on single interest insurance coverage insuring owners against unintentional tenant contract breaches failing to protect the apartment or multi-unit dwelling from losses from resident generated damage caused by fire, smoke, explosion, water discharge, and sewer backup.

2. A computer system according to claim 1, wherein the building physical information comprises the full name of the insured, the mailing addresses of the building units, the number of buildings and units, the fire insurance policy on the building and rating by the four basic types of construction recognized in fire insurance coverage, and including building owner coverage for negligence injuries by the tenant caused to third parties.

3. A computer system according to claim 2, wherein the database includes in addition a credit report on the tenant coded to meet legal confidentiality requirements, a criminal background check of the tenant, and a character reference check of the tenant to verify his past tenant conduct.

4. A computer system according to claim 1, wherein the system module adds commission and management fees to the actuarial insurance rates for inclusion in owner billings for the renters legal liability insurance.

5. A computer system according to claim 1, wherein the building physical information, relevant information, and tenant rental information is inputted monthly.

6. A computer system according to claim 1, wherein the working database is updated with information replies from mailed notices to uninsured tenants requesting insurance verification.

7. A computer system according to claim 1, wherein the system module generates and transmits trend report summaries of the status of uninsured tenants to authorized parties.

8. A computer system according to claim 1, wherein the data base contains data that includes:
i. the full name of the insured,
ii. the mailing addresses of the building units,
iii. the number of buildings and units,
iv. the fire insurance policy on the building and rating by the four basic types of construction: a) Class A buildings with walls, floors, and roof of masonry or concrete with all load walls supported by an independent steel frame, b) Class B similar to Class A except that interior walls and floors are not constructed of masonry or concrete, c) Class C building does not meet all specific requirements of Class B, and d) Class D building generally referring to frame structures recognized in fire insurance coverage,
v. actuarial insurance rates for renter's legal liability insurance,
vi. tenant rental information, which includes lease agreement requirements insuring owners against tenant contract breaches failing to protect the apartment or multi-unit dwelling from losses from resident generated damage caused by fire, smoke, explosion, water discharge, and sewer backup,
vii. limits of coverage,
viii. a credit report on the tenant coded to meet legal confidentiality requirements,
ix. a criminal background check of the tenant,
x. a character reference check of the tenant to verify past tenant conduct,
xi. tenant identity and insurance status of each occupied unit, and
xii. insurance carrier actuarial risk assessment pre-qualification requirements of the apartment or multi-unit dwelling for renter's legal liability insurance, and/or renters legal liability insurance with property damage liability waiver coverage insuring owners against tenant contract breaches failing to protect the apartment or multi-unit dwelling from losses from resident generated damage caused by fire, smoke, explosion, water discharge, and sewer backup,

9. A computer system according to claim 8, including a software module containing algorithms for generating property damage liability waiver (RLL PDLW) insurance coverage for the tenant, which provides a pre-set amount of coverage for the tenant's personal property, and optional additional sums for living expenses.

10. A computer system according to claim 9, wherein the renter's legal liability insurance covers the building owner's property for replacement cost.

11. A computer system according to claim 1, including:
a. a language converter to convert programing language insurance coverage to non-programmable owner readable language and issuing a renters legal liability single interest insurance policy to the non-occupying building owner, and
b. billing the owner for the renter's legal liability insurance coverage.

12. A computer system-according to claim 11, including providing on-line real time computer display access to tenants to purchase either renters legal liability insurance or renters legal liability insurance with property damage liability waiver coverage.

13. A computer method for gathering tenant occupancy and building data at individual tenant unit levels for more accurate risk/cost analysis to insure actuarial compliance for insuring apartments or multi-unit dwelling units with renters legal liability insurance where occupancy and tenant information continually change for renters liability insurance qualification requiring on-line computerized input or data exchange from property managers and their existing property management systems comprising:
a. entering data utilized for automated algorithm based decision making into a computer processor based automated system, which includes:
i. building physical information,
ii. the number of units in the apartment complex or multi-unit dwelling complex to qualify the complex for coverage,
iii. actuarial insurance rates for renter's legal liability insurance,
iv. lease agreement requirements insuring owners against tenant contract breaches failing to protect the apartment or multi-unit dwelling from losses from resident generated damage caused by fire, smoke, explosion, water discharge, and sewer backup,
v. tenant identity and insurance status of each occupied unit,
vi. insurance carrier actuarial risk assessment pre-qualification requirements of the apartment or multi-unit dwelling for renter's legal liability insurance, and/or renters legal liability insurance with property damage liability waiver (RLL PDLW) coverage insuring owners against tenant contract breaches failing to protect the apartment or multi-unit dwelling from losses from resident generated damage caused by fire, smoke, explosion, water discharge, and sewer backup,
vii. frequency review requirements for updates of the database regarding building occupancy and types of tenants to maintain pre-qualification status, and
viii. the identity of the insured non-occupying building owner and/or property manager of an apartment of multi-unit dwelling,
ix. internal data sets of pre-qualification unit level requirements for the apartment or multi-unit dwelling to verify eligibility of renters legal liability insurance via a qualifying matching algorithm that compares the remote input from the property manager or their property management system,
b. storing and tracking the insurance status of each tenant by monitoring the insurance carrier actuarial risk pre-qualification requirements and insuring that the pre-qualifications are maintained during operations of the apartment or multi-unit dwelling; and
c. generating by a system module replacement cost rates based on the number of insured units, and a percentage of the insured units additionally covered by third party insurance, and
issuing a renters legal liability insurance policy written on a group rate providing universal, capped, add-on single interest insurance coverage insuring owners against unintentional tenant contract breaches failing to protect the apartment or multi-unit dwelling from losses from resident generated damage caused by fire, smoke, explosion, water discharge, and sewer backup.

14. A computer method according to claim 13, wherein inputted data is looped to compare it with renters legal liability qualification data stored in the database for compliance using software modules with contained algorithms.

15. A computer method according to claim 14, wherein the data includes:
i. the full name of the insured,
ii. the mailing addresses of the building units,
iii. the number of buildings and units
iv. the fire insurance policy on the building and rating by the four basic types of construction: a) Class A buildings with walls, floors, and roof of masonry or concrete with all load walls supported by an independent steel frame, b) Class B similar to Class A except that interior walls and floors are not constructed of masonry or concrete, c) Class C building does not meet all specific requirements of Class B, and d) Class D building generally referring to frame structures recognized in fire insurance coverage,
v. actuarial insurance rates for renter's legal liability insurance,
vi. tenant rental information, which includes lease agreement requirements insuring owners against tenant contract breaches failing to protect the apartment or multi-unit dwelling from losses from resident generated damage caused by fire, smoke, explosion, water discharge, and sewer backup,
vii. limits of coverage,
viii. a credit report on the tenant coded to meet legal confidentiality requirements,
ix. a criminal background check of the tenant,
x. a character reference check of the tenant to verify past tenant conduct,
xi. tenant identity and insurance status of each occupied unit, and
xii. insurance carrier actuarial risk assessment pre-qualification requirements of the apartment or multi-unit dwelling for renter's legal liability insurance, and property damage liability waiver insurance coverage insuring owners against tenant contract breaches failing to protect the apartment or multi-unit dwelling from losses from resident generated damage caused by fire, smoke, explosion, water discharge, and sewer backup; and
checking and matching the tangible non-transitory with data entry check data and error memory database software when data is inputted to insure there is one entry record per unit.

16. A computer method according to claim 13, wherein maintaining pre-qualifications of the apartment or multi-unit dwelling to be eligible for renters legal liability insurance is made by:
a. periodically monitoring tenant data with a system module to evaluate the insurance status of each tenant by comparing the insurance carrier actuarial risk pre-qualification requirements and insuring that the pre-qualifications are maintained during operations of the apartment or multi-unit dwelling; and
b. evaluating replacement cost rates with a system module with an algorithm for renters legal liability insurance based on i) the building physical information and the number of insured units in the complex, ii) the limits of coverage, and iii) a percentage of the insured units additionally covered by third party insurance.

17. A computer method according to claim 13, including:
a. issuing a property damage liability waiver for the tenant, which includes traditional HO-4 form policy coverage from a linked web site of those companies providing HO-4 policy coverage for the tenant providing: i) a pre-set amount of personal property coverage for displaced tenants, ii) an additional sum for living expenses to the tenant unintentionally causing damage to the dwelling unit, and
b. billing a fee for providing traditional HO-4 form policies in the rent.

18. A computer method according to claim 17, wherein the billing also includes a fee for management.

19. A computer method according to claim 13 wherein the renter's legal liability insurance policy is in a permanent written or unalterable media embodiment listing the coverage provided covering the unit.

20. A computer method according to claim 19, wherein the renter's legal liability insurance policy includes additional property damage liability waiver insurance coverage, which also covers the tenant's personal property up to a pre-set amount in addition to damage to the unit.

21. A computer system for gathering tenant occupancy and building data at individual tenant unit level for more accurate risk/cost analysis to insure actuarial compliance for insuring apartments or multi-unit dwelling units with renters legal liability insurance where occupancy and tenant information continually changes for renters liability insurance qualification requiring on-line computerized input or data exchange from property managers and their existing property management systems comprising:
a. a computer system with data structures containing
i. non-occupying owner and building physical information about the apartment complex or multi-unit dwelling and number of units to qualify the complex for fire insurance coverage,
ii. tenant data including lease agreement requirements insuring owners against tenant contract breaches failing to protect the apartment or multi-unit dwelling from losses from resident generated damage caused by fire, smoke, explosion, water discharge, and sewer backup to qualify the complex or multi-unit dwelling for renter's legal liability insurance coverage,
iii. actuarial insurance rates for renter's legal liability insurance, and other relevant information,
iv. tenant identity and insurance status of each occupied unit,
v. insurance carrier actuarial risk assessment pre-qualification requirements of the apartment or multi-unit dwelling for renter's legal liability insurance, and/or property damage liability waiver insurance coverage insuring owners against tenant contract breaches failing to protect the apartment or multi-unit dwelling from losses from resident generated damage caused by fire, smoke, explosion, water discharge, and sewer backup, and
b. a computer system with modules and associated algorithms for:
i. insuring the insurance status of each tenant,
ii. maintaining pre-qualification of the apartment or multi-unit dwelling for renters legal liability insurance by periodically monitoring the insurance carrier pre-qualifications and insuring that the pre-qualifications are maintained during operations of the apartment or multi-unit dwelling, and
iii. generating renters legal liability insurance single interest insurance coverage insuring owners against unintentional tenant contract breaches failing to protect the apartment or multi-unit dwelling from losses from resident generated damage caused by fire, smoke, explosion, water discharge, and sewer backup based on the building physical information and number of units in the complex, and a percentage of the insured units in the apartment or multi-unit-dwelling additionally covered by third party renters insurance at a base replacement cost rate.

22. A computer system according to claim 21, including electronic signal transfer means to transmit coded electronic signals to a receiving translator, which converts the coded electronic signals into printed reports for authorized building owners, managers, or insurance carriers.

23. A computer system according to claim 21, including:
i. a language converter to convert the programing language insurance coverage to non-programmable owner readable language, and
ii. a system module to generate:
1) renters legal liability single interest insurance policy coverage insuring owners against unintentional tenant contract breaches failing to protect the apartment or multi-unit dwelling from losses from resident generated damage caused by fire, smoke, explosion, water discharge, and sewer backup,
2) property damage liability waiver insurance coverage for the tenant, which provides a pre-set amount of coverage for displaced tenants, and an additional sum for living expenses to the tenant unintentionally causing damage to the dwelling unit;
3) renters legal liability single interest insurance in a permanent unalterable media embodiment to the non-occupying owners as the named insured listing the coverage provided covering the apartment complex or multi-unit dwelling, and
4) a billing for the non-occupying owner and/or property manager for the renters legal liability insurance coverage, along with insurance rates to allow interested parties to purchase renters legal liability insurance.

24. A computer system according to claim 21, wherein the renters legal liability insurance protects the landowner from unintentional damage caused by the tenant from two or more perils selected from the group comprising fire, smoke, explosion, including the explosion of gases or fuel within the furnace of any fired vessel or within the flues or passages through which the gases of combustion pass: and water that backs up or overflows from a sewer, drain or sump, and water or other liquids that leak, flow or overflows from plumbing heating air conditioning, or other equipment fixtures, and negligence injuries by the tenant caused to third parties pursuant to predetermined insurability criteria.

25. A computer system according to claim 24, wherein the renters liability insurance protects the owner from unintentional damage caused by the tenant from three or more perils.

26. A computer system according to claim 24, wherein the renters liability insurance protects the owner from unintentional damage caused by the tenant from four or more perils.
